(19) United States
(12) Patent Application Publication
(10) Pub. No.: US 2025/0123647 A1
(43) Pub. Date: Apr. 17, 2025

(54) Driver Circuits And Methods For Supplying Leakage Current To Loads

(71) Applicant: Altera Corporation, San Jose, CA (US)

(72) Inventors: Muhammad Yousuf Siddiqui, San Mateo, CA (US); Maneesha Yellepeddi, Los Gatos, CA (US)

(73) Assignee: Altera Corporation, San Jose, CA (US)

(21) Appl. No.: 18/989,641

(22) Filed: Dec. 20, 2024

(51) Int. Cl. G05F 1/575

(52) U.S. Cl. CPC G05F 1/575

(57) ABSTRACT

An integrated circuit includes a first amplifier circuit coupled to receive a first voltage, a second amplifier circuit coupled to receive the first voltage, and a transistor. The second amplifier circuit is coupled to an output of the first amplifier circuit. An input of the transistor is coupled to an output of the second amplifier circuit. The transistor is coupled to the output of the first amplifier circuit. The second amplifier circuit varies a current through the transistor to the output of the first amplifier circuit based on a difference between the first voltage and a second voltage at the output of the first amplifier circuit to supply leakage current drawn by load circuits.

### BACKGROUND

Configurable integrated circuits (ICs) can be configured by users to implement desired custom logic functions. In a typical scenario, a logic designer uses computer-aided design (CAD) tools to design a custom circuit design. When the design process is complete, the computer-aided design tools generate an image containing configuration data bits. The configuration data bits are then loaded into configuration memory elements that configure configurable logic circuits in the integrated circuit to perform the functions of the custom circuit design.

### BRIEF DESCRIPTION OF DRAWINGS

FIG. 1 is a diagram that illustrates an example of a driver circuit that is configured to drive a voltage reference to load circuits in one or more integrated circuit (IC) dies.

FIG. 2 is a diagram that illustrates an example of a circuit system in which the driver circuit of FIG. 1 drives several load circuits in multiple integrated circuit (IC) dies.

FIG. 3 is a diagram that illustrates an example of a configurable logic IC that can implement techniques disclosed herein.

FIG. 4A is a block diagram of a system that can be used to implement a circuit design to be programmed into a programmable logic device using design software.

FIG. 4B is a diagram that depicts an example of a programmable logic device that includes fabric dies and base dies that are connected to one another via microbumps.

FIG. 5 is a block diagram illustrating a computing system configured to implement one or more aspects of the techniques disclosed herein.

### DETAILED DESCRIPTION

Many types of integrated circuits (ICs) have several analog circuits in various sub-systems that require stable reference voltages. The analog circuits typically have gate capacitive loads that generate gate leakage current in sub-nanometer semiconductor processes. Additionally, circuitry (i.e., an antenna diode) that is placed at the gates of field-effect transistors (FETs) in the ICs to avoid antenna errors exacerbates the leakage current. In circuit systems having multiple stacked integrated circuit (IC) dies, larger systems including several analog loads located in various IC dies can result in changing capacitive loads and increasing leakage currents for sub-nanometer semiconductor processes.

A two stage amplifier can be used to drive a reference voltage to analog circuits in an IC. A two stage amplifier and a single stage amplifier with a source follower both have current driving capability, but have limitations on the output capacitive load or are not load stable for all capacitances. To avoid instability with high capacitive loading, analog buffers can be cascaded, and the reference voltage can be fanned out to limit the capacitive loading on a single buffer. This technique is not scalable for many types of ICs. Also, each intermediate analog buffer stage adds offset to the main reference voltage leading to inaccuracy, and each intermediate analog buffer stage consumes current that leads to higher power dissipation in the IC.

According to some examples disclosed herein, a first single stage amplifier circuit is provided in a unity gain configuration for distributing a single reference voltage across sub-systems in a single integrated circuit (IC) die or across multiple IC dies (e.g., through a layer on a package substrate). A second amplifier circuit is coupled to the first amplifier circuit. The second amplifier circuit provides on-demand leakage current support for the first amplifier circuit. The second amplifier circuit assists the first amplifier circuit to provide a stable reference voltage to any number of loads having capacitance and drawing leakage current. The second amplifier circuit assists the first amplifier circuit to provide a stable reference voltage across process variations in leakage current drawn by the loads. A transistor (e.g., a FET) is coupled to the outputs of the amplifier circuits and provides current to offset the leakage current. The amplifier circuits and the transistor can generate a stable and accurate reference voltage across one or more IC dies, without adding excessive area, power consumption, or cost, in response to loads having varying (e.g., increasing) leakage current and load capacitance.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the terms “connected” and “connection” mean a direct electrical connection between the circuits that are connected, without any intermediary devices. The terms “coupled” and “coupling” mean either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs) and programmable logic devices. As discussed herein, an integrated circuit (IC) can include hard logic and/or soft logic. The circuits in an integrated circuit device (e.g., in a configurable logic IC) that are configurable by an end user are referred to as “soft logic.” “Hard logic” generally refers to circuits in an integrated circuit device that have substantially fewer configurable features than soft logic or no configurable features.

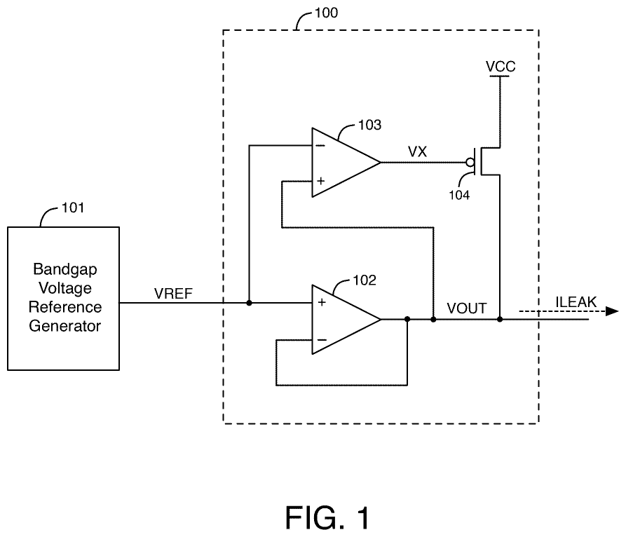

FIG. 1 is a diagram that illustrates an example of a driver circuit 100 that is configured to drive a voltage reference to load circuits in one or more integrated circuit (IC) dies. Driver circuit 100 is in an integrated circuit (IC) die. The IC die can be any type of IC die, such as, a configurable IC (e.g., a field programmable gate array (FPGA) or programmable logic device), a microprocessor IC, a graphics processing unit (GPU) IC, a memory IC, an application specific IC, a transceiver IC, a memory IC, or any combination thereof.

Figure (FIG. 1 shows a bandgap voltage reference generator circuit 101 that generates a bandgap reference voltage VREF that has a constant voltage across variations in the temperature of the IC, the process of the IC, and the supply voltage in the IC. Driver circuit 100 includes a unity gain amplifier circuit 102, a second amplifier circuit 103, and a p-channel field-effect transistor (FET) 104 (e.g., a p-channel metal oxide semiconductor field effect transistor or MOSFET).

The amplifier circuit 102 is a single stage folded cascode amplifier circuit configured in a unity gain configuration. Although driver circuit 100 includes a folded cascode amplifier circuit 102 in this example, any type of single stage amplifier circuit can be used in place of the amplifier circuit 102. The amplifier circuit 103 is also a single stage amplifier circuit that can be of the same type as amplifier circuit 102.

The bandgap reference voltage VREF generated by the bandgap voltage reference generator circuit 101 is provided to the inverting input of amplifier circuit 103 and to the non-inverting input of amplifier circuit 102. The output of the amplifier circuit 102 is coupled to the inverting input of amplifier circuit 102 in a unity gain configuration. The output of the amplifier circuit 102 is also coupled to the non-inverting input of amplifier circuit 103, to the drain of transistor 104, and to load circuits that are not shown in FIG. 1. The amplifier circuit 102 generates an output voltage VOUT at its output. The load circuits that are coupled to the output of the amplifier circuit 102 receive the output voltage VOUT of the amplifier circuit 102 as a reference voltage. Amplifier circuit 102 functions as a buffer circuit that causes voltage VOUT to equal reference voltage VREF. The load circuits may also draw leakage current ILEAK from driver circuit 100.

The output of amplifier circuit 103 is coupled to the gate of p-channel transistor 104 at voltage VX. The source of transistor 104 is coupled to a supply terminal at a supply voltage VCC. Transistor 104 functions as a voltage controlled current source. If the leakage current ILEAK drawn from driver circuit 100 by the load circuits is zero, the output voltage VOUT of the amplifier circuit 102 equals voltage VREF. When the voltages VREF and VOUT at the inputs of amplifier circuit 103 are equal, the output voltage VX of amplifier circuit 103 is at a voltage that is high enough to prevent the p-channel transistor 104 from supplying any current to the output of amplifier circuit 102 at voltage VOUT. Thus, transistor 104 is off, and voltage VOUT remains constant.

As the leakage current ILEAK drawn by the load circuits increases as a result of temperature changes, an increase in the number of load circuits, and/or an increase in the current drawn by the load circuits, the output voltage VOUT starts decreasing by a small amount, as current is being drawn from amplifier circuit 102 to the load circuits. Without transistor 104 and amplifier circuit 103, the output voltage VOUT of the amplifier circuit 102 continues to decrease, generating a voltage error in output voltage VOUT that varies with (i.e., is dependent on) loading, temperature, and process.

As the output voltage VOUT of amplifier circuit 102 decreases in the driver circuit 100, the output voltage VX of the amplifier circuit 103 (i.e., the gate voltage of transistor 104) also decreases. As the gate voltage VX of transistor 104 decreases, the current through transistor 104 from the supply terminal at voltage VCC to the output of amplifier circuit 102 increases. This current through transistor 104 from the supply terminal causes the output voltage VOUT to increase back to the reference voltage VREF. This process continues until the transistor 104 provides all the leakage current that is currently being drawn by the load circuits. In this equilibrium state, the output voltage VOUT equals the reference voltage VREF, and all the leakage current drawn by the load circuits is provided by the transistor 104. As a result, no bias current is drawn from the amplifier circuit 102 by the load circuits, and no error occurs in the direct current (DC) output voltage VOUT value.

Thus, as the leakage current ILEAK increases (e.g., by microamps) because of providing more load circuits coupled to the output of the amplifier circuit 102, the output voltage VOUT of the amplifier circuit 102 remains substantially constant (e.g., varies by 1 millivolt or less). As the temperature of the IC increases, the leakage current ILEAK drawn by the load circuits increases, but the output voltage VOUT of the amplifier circuit 102 continues to remain substantially constant.

Thus, the driver circuit 100 compensates for the leakage current ILEAK using single stage amplifier circuits 102-103 to drive load circuits having any capacitance across an entire IC die or across multiple IC dies (e.g., three-dimensional or disaggregated IC dies) without using any intermediate buffer circuits between the load circuits, providing silicon area and power savings, while eliminating error in the output voltage VOUT caused by the leakage current.

The driver circuit 100 can provide the output voltage VOUT at a stable voltage level to several load circuits (e.g., analog load circuits) in one or more IC dies. The driver circuit 100 is scalable for die-disaggregated field programmable gate arrays (FPGAs) and other types of IC dies. A single bandgap voltage reference generator circuit 101 is used to provide a reference voltage VREF to multiple sub-systems in one or more IC dies through on-chip routing and/or die-to-die interconnect, regardless of the number of load circuits in the one or more IC dies.

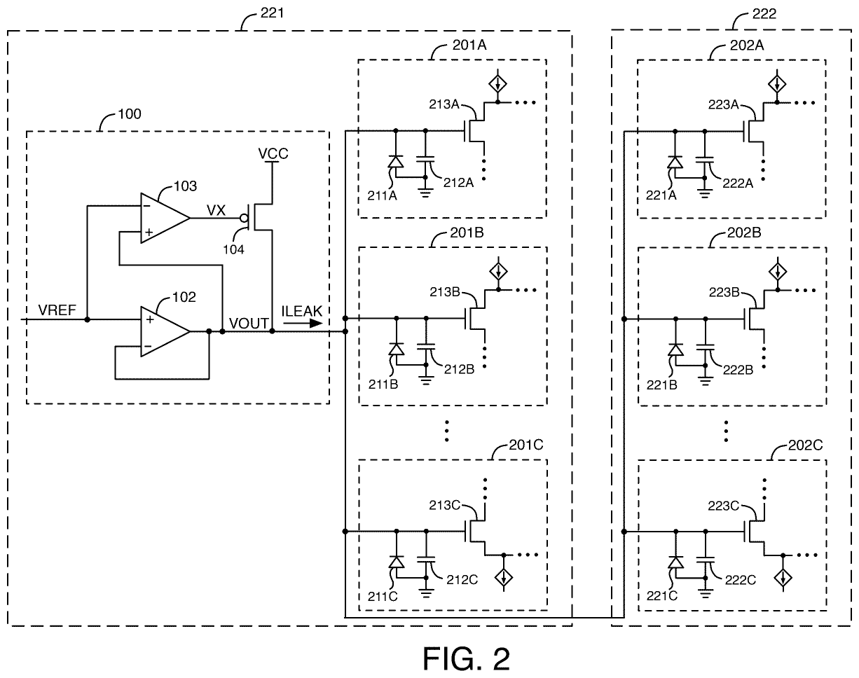

FIG. 2 is a diagram that illustrates an example of a circuit system in which the driver circuit 100 of FIG. 1 drives several load circuits in multiple integrated circuit (IC) dies. The circuit system of FIG. 2 includes two IC dies 221 and 222. IC die 221 includes the driver circuit 100 and three or more load circuits 201, including load circuits 201A, 201B, and 201C. IC die 222 includes three or more load circuits 202, including load circuits 202A, 202B, and 202C. The load circuits 201 and 202 can be, as an example, analog circuits. Load circuits 201A-201C include diodes 211A-211C, capacitors 212A-212C, and n-channel (or p-channel) field-effect transistors (FETs) 213A-213C, respectively. Load circuits 202A-202C include diodes 221A-221C, capacitors 222A-222C, and n-channel (or p-channel) FETs 223A-223C, respectively.

The load circuits 201 are coupled to the driver circuit 100 at the output of amplifier circuit 102 that provides output voltage VOUT through conductors entirely within IC die 221. The load circuits 202 are coupled to the driver circuit 100 at the output of amplifier circuit 102 that provides output voltage VOUT through conductors in each of the IC dies 221 and 222 and through one or more external conductors that couple IC dies 221-222 together.

Each of the load circuits 201 and 202 potentially draws leakage current from driver circuit 100 through these conductors during operation of the IC dies 221-222. As the leakage current ILEAK drawn by the load circuits 201-202 varies, the output voltage VOUT varies by small amounts in response to the changes in the current being drawn from amplifier circuit 102 to the load circuits. In response to the small changes in output voltage VOUT, amplifier circuit 103 varies the current through transistor 104 from the supply terminal to the output of amplifier circuit 102 at output voltage VOUT, so that the current through transistor 104 supplies the leakage current ILEAK being drawn by the load circuits 201-202. As a result, as the leakage current ILEAK varies, the output voltage VOUT of amplifier circuit 102 remains substantially constant.

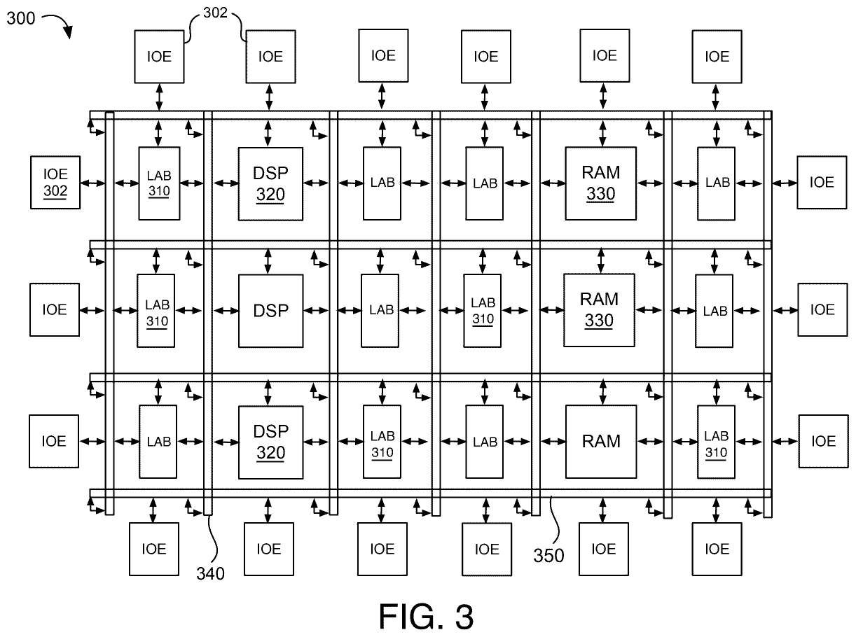

FIG. 3 is a diagram that illustrates an example of a configurable logic IC 300 that can implement techniques disclosed herein. The driver circuit 100 and the load circuits disclosed herein with respect to FIGS. 1 and 2 can be fabricated in configurable logic IC 300 according to some examples. As shown in FIG. 3, the configurable logic IC 300 includes a two-dimensional array of configurable functional circuit blocks, including configurable logic array blocks (LABs) 310 and other functional circuit blocks, such as random access memory (RAM) blocks 330 and digital signal processing (DSP) blocks 320. Functional blocks such as LABs 310 can include smaller configurable logic circuits (e.g., logic elements, logic blocks, or adaptive logic modules) that receive input signals and perform custom functions on the input signals to produce output signals.

In addition, configurable logic IC 300 can have input/output elements (IOEs) 302 for driving signals off of configurable logic IC 300 and for receiving signals from other devices. IOEs 302 may include parallel input/output circuitry, serial data transceiver circuitry, differential receiver and transmitter circuitry, or other circuitry used to connect one integrated circuit to another integrated circuit. As shown, IOEs 302 may be located around the periphery of the chip. If desired, the configurable logic IC 300 may have IOEs 302 arranged in different ways. For example, IOEs 302 may form one or more columns, rows, or islands of input/output elements that may be located anywhere on the configurable IC 300. Input/output elements 302 can include general purpose input/output (GPIO) circuitry (e.g., on the top and bottoms edges of IC 300), high-speed input/output (HSIO) circuitry (e.g., on the left edge of IC 300), and on-package input/output (OPIOs) circuitry (e.g., on the right edge of IC 300).

The configurable logic IC 300 can also include programmable interconnect circuitry in the form of vertical routing channels 340 (i.e., interconnects formed along a vertical axis of configurable logic IC 300) and horizontal routing channels 350 (i.e., interconnects formed along a horizontal axis of configurable logic IC 300), each routing channel including at least one track to route at least one wire. One or more of the routing channels 340 and/or 350 can be part of a network-on-chip (NOC) having router circuits.

Note that other routing topologies, besides the topology of the interconnect circuitry depicted in FIG. 3, can be used. For example, the routing topology may include wires that travel diagonally or that travel horizontally and vertically along different parts of their extent as well as wires that are perpendicular to the device plane in the case of three dimensional integrated circuits. The driver of a wire may be located at a different point than one end of a wire.

Furthermore, it should be understood that embodiments disclosed herein with respect to FIGS. 1-2 can be implemented in any integrated circuit or electronic system. If desired, the functional blocks of such an integrated circuit can be arranged in more levels or layers in which multiple functional blocks are interconnected to form still larger blocks. Other device arrangements can use functional blocks that are not arranged in rows and columns.

Configurable logic IC 300 can contain programmable memory elements. Memory elements can be loaded with configuration data bits using IOEs 302. Once loaded, the memory elements each provide a corresponding static control signal that controls the operation of an associated configurable functional block (e.g., LABs 310, DSP blocks 320, RAM blocks 330, or IOEs 302). The configuration data bits can set the functions of the configurable functional circuit blocks (i.e., soft logic) in IC 300.

In a typical scenario, the outputs of the loaded memory elements are applied to the gates of field-effect transistors in a functional block to turn certain transistors on or off and thereby configure the logic in the functional block including the routing paths. Programmable logic circuit elements that are controlled in this way include parts of multiplexers (e.g., multiplexers used for forming routing paths in interconnect circuits), look-up tables, logic arrays, AND, OR, NAND, and NOR logic gates, pass gates, etc.

The memory elements can use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data bits during programming, the memory elements are sometimes referred to as configuration memory or programmable memory elements.

The memory elements can be organized in a configuration memory array consisting of rows and columns. A data register that spans across all columns and an address register that spans across all rows may receive configuration data bits. The configuration data bits can be shifted onto the data register. When the appropriate address register is asserted, the data register writes the configuration data bits to the configuration memory bits of the row that was designated by the address register.

Configurable integrated circuit 300 can include configuration memory that is organized in sectors, whereby a sector can include the configuration bits that specify the function and/or interconnections of the subcomponents and wires in or crossing that sector. Each sector can include separate data and address registers.

The configurable IC of FIG. 3 is merely one example of an IC that can include embodiments disclosed herein. The embodiments disclosed herein may be incorporated into any suitable integrated circuit or system. For example, the embodiments disclosed herein can be incorporated into numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

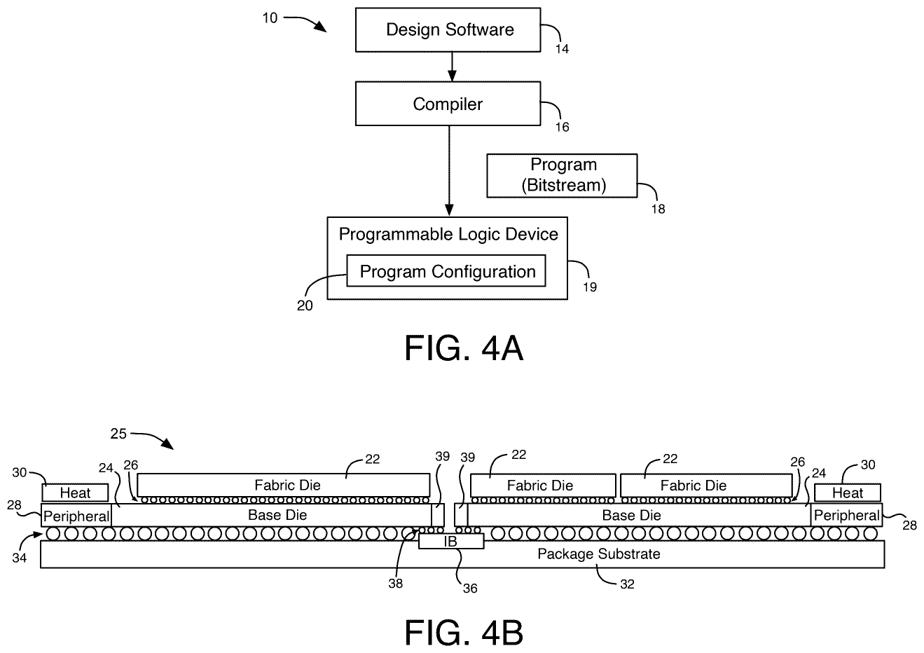

FIG. 4A illustrates a block diagram of a system 10 that can be used to implement a circuit design to be programmed onto a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized tasks.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 4B, but many others can be used, and it should be understood that this disclosure is intended to encompass any suitable programmable logic device where programmable logic fabric and fabric support circuitry are at least partially separated on different integrated circuit die.

FIG. 4B is a diagram that depicts an example of the programmable logic device 25 that includes three fabric die 22 and two base die 24 that are connected to one another via microbumps 26. In the example of FIG. 4B, at least some of the programmable logic fabric of the programmable logic device 25 is in the three fabric die 22, and at least some of the fabric support circuitry that operates the programmable logic fabric is in the two base die 24. For example, some of the circuitry of configurable IC 300 shown in FIG. 3 (e.g., LABs 310, DSP 320, RAM 330) can be located in the fabric die 22 and some of the circuitry of IC 300 (e.g., input/output elements 302) can be located in the base die 24.

Although the fabric die 22 and base die 24 appear in a one-to-one relationship or a two-to-one relationship in FIG. 4B, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 25. The heat spreaders 30 can appear above, as pictured, and/or below the package (e.g., as a double-sided heat sink). The base die 24 can attach to a package substrate 32 via conductive bumps 34. In the example of FIG. 4B, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 25 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

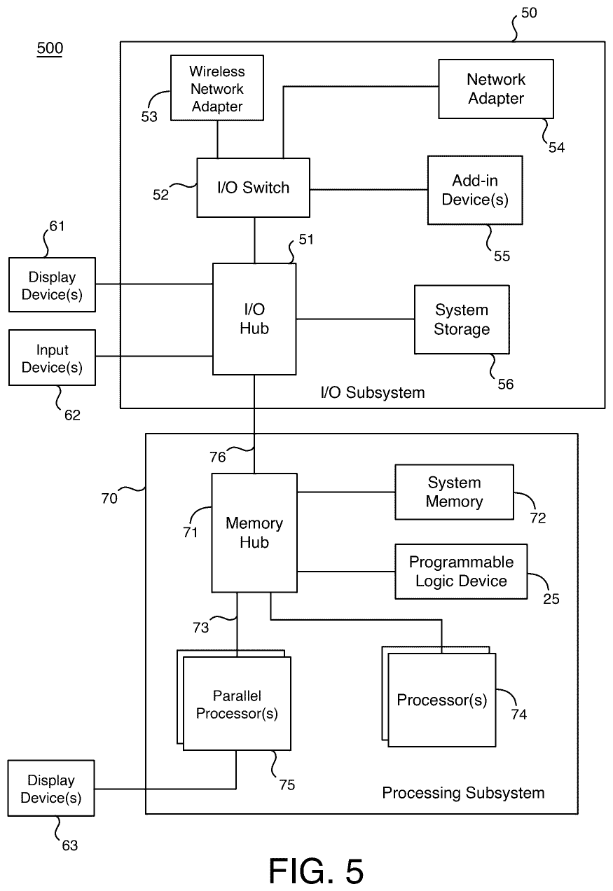

FIG. 5 is a block diagram illustrating a computing system 500 configured to implement one or more aspects of the embodiments described herein. The computing system 500 includes a processing subsystem 70 having one or more processor(s) 74, a system memory 72, and a programmable logic device 25 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 500 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 500. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 500 can include other components not shown in FIG. 5, including other port connections, optical storage drives, video capture devices, and the like, that can also be connected to the I/O hub 51. Communication paths interconnecting the various components in FIG. 5 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 500 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 500 can be integrated into a single package to form a system in package (SIP) configuration. In one embodiment, at least a portion of the components of the computing system 500 can be integrated into a multi-chip module (MCM), which can be interconnected with other multi-chip modules into a modular computing system.

The computing system 500 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 500. For example, any number of add-in cards or peripherals can be supported, or some components can be eliminated. Furthermore, some architectures can use different terminology for components similar to those illustrated in FIG. 5. For example, the memory hub 71 can be referred to as a Northbridge in some architectures, while the I/O hub 51 can be referred to as a Southbridge.

Additional examples are now described. Example 1 is an integrated circuit comprising: a first amplifier circuit coupled to receive a first voltage; a second amplifier circuit coupled to receive the first voltage, wherein the second amplifier circuit is coupled to a first output of the first amplifier circuit; and a transistor comprising a first input coupled to a second output of the second amplifier circuit, wherein the transistor is coupled to the first output of the first amplifier circuit, and wherein the second amplifier circuit varies a first current through the transistor to the first output of the first amplifier circuit based on a difference between the first voltage and a second voltage at the first output of the first amplifier circuit to supply leakage current drawn by load circuits.

In Example 2, the integrated circuit of Example 1 may optionally include, wherein the first amplifier circuit and the second amplifier circuit are coupled in a single stage configuration.

In Example 3, the integrated circuit of any one of Examples 1-2 may optionally include, wherein the second amplifier circuit varies the first current through the transistor to the first output of the first amplifier circuit to maintain the second voltage substantially constant.

In Example 4, the integrated circuit of any one of Examples 1-3 may optionally include, wherein the first amplifier circuit is coupled in a unity gain configuration.

In Example 5, the integrated circuit of any one of Examples 1-4 may optionally include, wherein the second amplifier circuit varies the first current through the transistor to provide compensation for the leakage current across variations in temperature and process of the integrated circuit.

In Example 6, the integrated circuit of any one of Examples 1-5 may optionally include, wherein the transistor is a p-channel field-effect transistor coupled between a supply terminal and the output of the first amplifier circuit.

In Example 7, the integrated circuit of any one of Examples 1-6 further comprises: a bandgap voltage reference generator circuit that generates the first voltage as a bandgap reference voltage.

In Example 8, the integrated circuit of any one of Examples 1-7 may optionally include, wherein the load circuits are in the integrated circuit.

In Example 9, the integrated circuit of any one of Examples 1-8 may optionally include, wherein the load circuits are multiple integrated circuit dies.

Example 10 is a method for providing stability in an output voltage provided to load circuits, the method comprising: receiving a reference voltage at inputs of first and second amplifier circuits; generating the output voltage at a first output of the first amplifier circuit based on the reference voltage; and adjusting a first current through a transistor to the first output of the first amplifier circuit using the second amplifier circuit based on a difference between the reference voltage and the output voltage to provide leakage current drawn by the load circuits that are coupled to the first output of the first amplifier circuit.

In Example 11, the method of Example 10 may optionally include, wherein adjusting the first current through the transistor further comprises adjusting the first current through the transistor to the first output of the first amplifier circuit using the second amplifier circuit to maintain the output voltage substantially constant.

In Example 12, the method of any one of any one of Examples 10-11 may optionally include, wherein the first amplifier circuit is a single stage folded cascode amplifier circuit.

In Example 13, the method of any one of Examples 10-12 may optionally include, wherein the first and the second amplifier circuits are coupled in a single stage configuration.

In Example 14, the method of any one of Examples 10-13 may optionally include, wherein the load circuits are in a single integrated circuit die.

In Example 15, the method of any one of Examples 10-14 may optionally include, wherein the load circuits are in multiple integrated circuit dies.

Example 16 is a driver circuit comprising: a buffer circuit that buffers a reference voltage to generate an output voltage that is provided to load circuits; a transistor coupled to an output of the buffer circuit; and an amplifier circuit coupled to the buffer circuit, wherein the amplifier circuit varies a first current through the transistor to the output of the buffer circuit based on a difference between the reference voltage and the output voltage to maintain the output voltage substantially constant across variations in leakage current drawn by the load circuits.

In Example 17, the driver circuit of Example 16 may optionally include, wherein the amplifier circuit varies the first current through the transistor to provide compensation for the leakage current across variations in temperature and process of the driver circuit.

In Example 18, the driver circuit of any one of Examples 16-17 may optionally include, wherein buffer circuit is coupled in a unity gain configuration.

In Example 19, the driver circuit of any one of Examples 16-18 may optionally include, wherein the buffer circuit and the amplifier circuit are coupled in a single stage configuration.

In Example 20, the driver circuit of any one of Examples 16-19 may optionally include, wherein the driver circuit is in a first integrated circuit, and wherein the load circuits are in at least one of the first integrated circuit or a second integrated circuit.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An integrated circuit comprising:
a first amplifier circuit coupled to receive a first voltage;
a second amplifier circuit coupled to receive the first voltage, wherein the second amplifier circuit is coupled to a first output of the first amplifier circuit; and
a transistor comprising a first input coupled to a second output of the second amplifier circuit, wherein the transistor is coupled to the first output of the first amplifier circuit, and wherein the second amplifier circuit varies a first current through the transistor to the first output of the first amplifier circuit based on a difference between the first voltage and a second voltage at the first output of the first amplifier circuit to supply leakage current drawn by load circuits.

2. The integrated circuit of claim 1, wherein the first amplifier circuit and the second amplifier circuit are coupled in a single stage configuration.

3. The integrated circuit of claim 1, wherein the second amplifier circuit varies the first current through the transistor to the first output of the first amplifier circuit to maintain the second voltage substantially constant.

4. The integrated circuit of claim 1, wherein the first amplifier circuit is coupled in a unity gain configuration.

5. The integrated circuit of claim 1, wherein the second amplifier circuit varies the first current through the transistor to provide compensation for the leakage current across variations in temperature and process of the integrated circuit.

6. The integrated circuit of claim 1, wherein the transistor is a p-channel field-effect transistor coupled between a supply terminal and the output of the first amplifier circuit.

7. The integrated circuit of claim 1 further comprising:
a bandgap voltage reference generator circuit that generates the first voltage as a bandgap reference voltage.

8. The integrated circuit of claim 1, wherein the load circuits are in the integrated circuit.

9. The integrated circuit of claim 1, wherein the load circuits are multiple integrated circuit dies.

10. A method for providing stability in an output voltage provided to load circuits, the method comprising:
receiving a reference voltage at inputs of first and second amplifier circuits;
generating the output voltage at a first output of the first amplifier circuit based on the reference voltage; and
adjusting a first current through a transistor to the first output of the first amplifier circuit using the second amplifier circuit based on a difference between the reference voltage and the output voltage to provide leakage current drawn by the load circuits that are coupled to the first output of the first amplifier circuit.

11. The method of claim 10, wherein adjusting the first current through the transistor further comprises adjusting the first current through the transistor to the first output of the first amplifier circuit using the second amplifier circuit to maintain the output voltage substantially constant.

12. The method of claim 10, wherein the first amplifier circuit is a single stage folded cascode amplifier circuit.

13. The method of claim 10, wherein the first and the second amplifier circuits are coupled in a single stage configuration.

14. The method of claim 10, wherein the load circuits are in a single integrated circuit die.

15. The method of claim 10, wherein the load circuits are in multiple integrated circuit dies.

16. A driver circuit comprising:
a buffer circuit that buffers a reference voltage to generate an output voltage that is provided to load circuits;
a transistor coupled to an output of the buffer circuit; and
an amplifier circuit coupled to the buffer circuit, wherein the amplifier circuit varies a first current through the transistor to the output of the buffer circuit based on a difference between the reference voltage and the output voltage to maintain the output voltage substantially constant across variations in leakage current drawn by the load circuits.

17. The driver circuit of claim 16, wherein the amplifier circuit varies the first current through the transistor to provide compensation for the leakage current across variations in temperature and process of the driver circuit.

18. The driver circuit of claim 16, wherein the buffer circuit is coupled in a unity gain configuration.

19. The driver circuit of claim 16, wherein the buffer circuit and the amplifier circuit are coupled in a single stage configuration.

20. The driver circuit of claim 16, wherein the driver circuit is in a first integrated circuit, and wherein the load circuits are in at least one of the first integrated circuit or a second integrated circuit.
